(19) United States
(12) Patent Application Publication
(10) Pub. No.: US 2010/0241525 A1
(43) Pub. Date: Sep. 23, 2010

(54) IMMERSIVE VIRTUAL COMMERCE

(75) Inventors: Blaise H. Aguera y Arcas, Seattle, WA (US); Richard Stephen Szeliski, Bellevue, WA (US); Stephen L. Lawler, Redmond, WA (US); Eyal Ofek, Redmond, WA (US); Jason Leslie Szabo, Erie, CO (US); Steven Ned Stanzel, Boulder, CO (US); Gur Kimchi, Bellevue, WA (US); Avi Bar-Zeev, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/406,903

(22) Filed: Mar. 18, 2009

(51) Int. Cl. G06Q 30/00; G06F 17/30; G06F 3/048

(52) U.S. Cl. 705/27; 715/757; 707/E17.014

(57) ABSTRACT

An immersive virtual store can be presented to a user that allows the user to navigate through the store in a manner similar to a physical store. The presented virtual store can allow the user to travel along aisles, stop and browse items at a table of a vendor, as well as perform searches for different items. Items of the store can be arranged in a manner that facilitates purchase and feedback of the arrangement can be collected and used in other arrangements.

### TECHNICAL FIELD

The subject specification relates generally to ecommerce and in particular to use of immersive virtual commerce.

### BACKGROUND

The Internet has introduced disruptive technologies to the retail shopping domain. Traditionally, consumers often would commute to a retail establishment, park his/her car, and walk through the retail establishment to locate items of interest. Thereafter, the consumer would need to wait in line at a cash register to purchase selected items.

Online shopping has displayed market share of traditional brick-and-mortar retail stores. Some of the aforementioned tasks associated with traditional stores are alleviated by online shopping. For instance, in an online shopping experience a consumer can browse items, perform text searches at home, office, etc., rather than having to expend valuable time and resources commuting to a store. Additionally, online stores are open continuously allowing consumers to shop at times convenient for them. Accordingly, shoppers reap many benefits by shopping on-line, for example: saving time by not having to travel, avoiding long lines and delay, not expending funds on items such as fuel for a travel vehicle, quickly ascertaining if there is appropriate inventory for a desired item, etc. There can also be benefits in providing online shopping from a seller's perspective. It can be expensive to employ sales associates in distinct stores as well as costly to rent or own buildings that consume overhead (e.g., electricity, heating, fees, etc.). Due to these benefits, online shopping has gained significant market share and an acceptance as a forum to effect commercial transactions.

However, there are limitations with online shopping. For instance, goods disclosed on a store web page commonly include a limited text description and thumbnail photograph. Moreover, images and inventory are represented in a two-dimensional manner, which does not allow a user to fully examine merchandise. Since a two-dimensional interface is presented to the user, there can be a learning curve associated with navigating a shopping Internet page since the two-dimensional interface likely differs greatly from an actual brick-and-mortar store. Thus, a shopper is not able to appreciate the goods fully, is limited in an ability to view merchandise, and can lose aspects experienced during traditional shopping. Therefore, the traditional brick-and-mortar stores still function to provide a shopping experience not matched by online shopping.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

This innovation allows a shopper to navigate through an online shopping experience in a similar manner to a brick-and-mortar store. Through use of an avatar or other construct, the shopper can travel through a virtual store and/or visit specific aisles within the virtual store, which can represent a traditional brick-and-mortar store. This can enable a user to have an experience similar to that of a traditional store with the convenience and benefits of online shopping. Various features can be integrated in the virtual store to enhance functionality—for instance, the shopper could use a search feature to find items of interest and the avatar could be automatically moved near a designated item of interest.

Items available for sale can be depicted as audio-visual representations based upon physical characteristics of the items, such as three-dimensional renderings of physical packaging. These audio-visual representations can be mapped together and a virtual market can be produced based on the mapping; moreover, this virtual market can be presented to a shopper. The shopper can navigate the virtual market, view audio-visual representations of available items, and purchase inventory items depicted by audio-visual representations without need to use a text product description.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative immersive virtual commerce market with support components in accordance with an aspect of the subject specification.

FIG. 2 illustrates a representative immersive virtual commerce market production system in accordance with an aspect of the subject specification.

FIG. 3 illustrates a representative item arrangement system in accordance with an aspect of the subject specification.

FIG. 4 illustrates a representative system with detailed generation and peregrinate components in accordance with an aspect of the subject specification.

FIG. 5 illustrates a representative system with component to provide additional functionality for an immersive virtual commerce market in accordance with an aspect of the subject specification.

FIG. 6 illustrates a representative arrangement methodology in accordance with an aspect of the subject specification.

FIG. 7 illustrates a representative methodology for producing an immersive virtual commerce market with various functionality in accordance with an aspect of the subject specification.

FIG. 8 illustrates a representative methodology for performing operations in relation to an immersive virtual commerce market in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

This immersive virtual shopping experience allows users to travel in and through stores and select items for examination and/or purchase. Thus, the immersive virtual shopping experience mimics shopping in a physical market (e.g., collection of at least one store, collection of venders—such as being at a flea market, etc.). Maneuvering through the market can occur such as walking into different stores as well as traversing through a particular store. In addition to traditional shopping, enhanced functionality in the immersive virtual shopping experience allows the user to complete tasks outside of those able to be completed in physical store. For example, a shopper in an immersive virtual shopping experience can concurrently search and browse while a consumer in a physical market is limited to browsing.

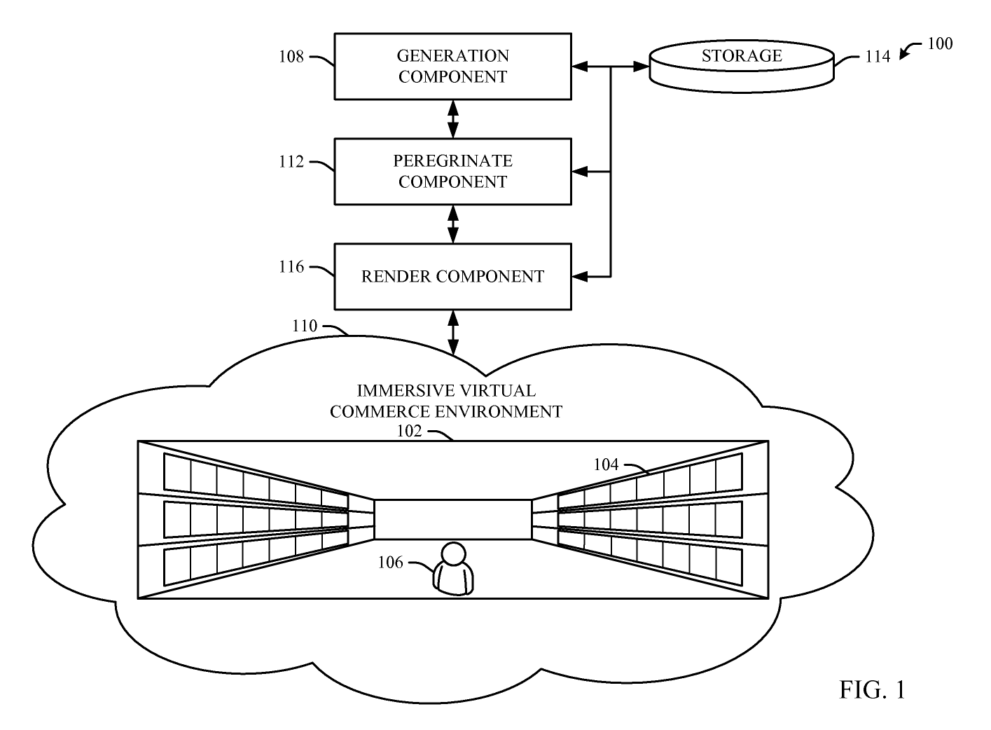

An example configuration 100 is depicted in FIG. 1; the configuration 100 represents a virtual store 102 upon which a user can traverse with physical items 104 placed on shelves. A user can travel through the aisles in either a first or third-person view; for instance, an avatar 106 represents a third-person view. In either view, a person can maneuver through the store and select different items; when an item is selected, metadata (e.g., price, calories, weight, etc.) pertaining to the item can be made available. Specific items can be chosen, placed in the shopping cart, and/or purchased. As such, there can be a generation component 108 that produces an immersive virtual commerce environment 110 and a peregrinate component 112 that facilitates navigation through the immersive virtual commerce environment 110 and thus allows a user to traverse through the virtual store 102. The virtual store 102 can be retained upon storage 114 and disclosed (e.g., through a render component 116) when requested by a user

There can be implementation of a search feature for use in conjunction with the environment. This search feature could enable a user to find a desired item quickly and easily. Considering the virtual grocery store described above, a user may desire to find a certain bean. The user could search through the store or a relatively static list to find the desired bean; on the other hand, the user can be provided with a visual interface representing different bean types and brands. Instead of a list of bean items being presented to the user, a physical construct could be presented to the user that can display packaging, location in the store, etc. Additionally, bean representations can be removed off shelves of the virtual store and presented on a topmost visual layer and after selection (or lack thereof), the bean representations can return to previous locations and navigation can resume. The user can select a bean item for purchase—with this selection, the bean item can be placed in the cart, the user can be transported to a location in the virtual store where the item is located, and the like. Thus, while searching takes place, there can still be mainlining of store physicality.

Moreover, location or presentation of items within the virtual environment can be personalized on a per user basis (e.g., as a function of preferences, profiles, historical shopping habits, . . . ). Thus, in two instances of a virtual environment for two different consumers the same set of virtual rooms can be rendered and customized (and thus differ per consumer) on an individual basis.

Aside from product searching, such as typing beans and relevant beans being disclosed, other searching implementations can be practiced with available items being presented in a similar manner. For instance, a user can request that there be a breakfast food item that is under a certain number of calories. In another example, a user can highlight beans and make a request for other items that can be used in a chili recipe.

The generation component 108 can produce the environment through different embodiments and implement the environment with various visual features. For instance, a number of photographs can be stitched together in a manner that facilitates movement through the virtual environment. Different rooms can be made available to a user through doorways—when the user selects a doorway, generation and rendering of a virtual environment can occur in real time. Therefore, when a user decides a room should be entered, rendering can occur tailored to a shopping experience to the user. For instance, if the user enters a first room and places a product in a cart and chooses to travel to a second room, then when rendering the second room an inference can be drawn that similar items to the placed product should not be shown since there is a relatively high likelihood the user has made a decision on the product. Moreover, rendering can occur where there is auto-placement of items as a function of user demographics, inferring what a user wants based on other purchases, timely and relevant presentation of advertisements, coupons, or the like.

Also, the user can configure the environment based on personal desires - the configuration can be for global use as well as session use. For example, a user can modify a room to make the room larger, include more inventory items, include specific types of inventory items, and the like. The user can also select room color, room pattern, room layout, and others. User configurations can occur when originally producing an environment as well as be implemented after creation. A personal profile can be associated with the user and when the user makes specific configurations, the configurations can be saved with the profile and used in later generation. The profile (or associated component) can be intelligent such that learning can occur based upon aggregate configurations made by the user.

Navigation with the peregrinate component 112 can facilitate seamless travel through the environment. For example, the environment can enable a user to travel around corners, under objects, and the like. Through the navigation, the user can be constrained in movement—the constraints can mirror movement limitations in the physical world as well as be tailored for a virtual experience. Movement abilities can also be provided to a user, such as an ability to fly from one location to another or teleport to a location can be provided by the peregrinate component 112 if determined to be appropriate. In addition, different levels can be used in the environment connected by a virtual staircase or elevator. When the user enters the virtual elevator, a door can close and production of another floor can occur while an image is displayed of the user travelling in the elevator—therefore, a user can be under an impression that the environment is seamless, yet partial generation occurs on a need or appropriateness basis.

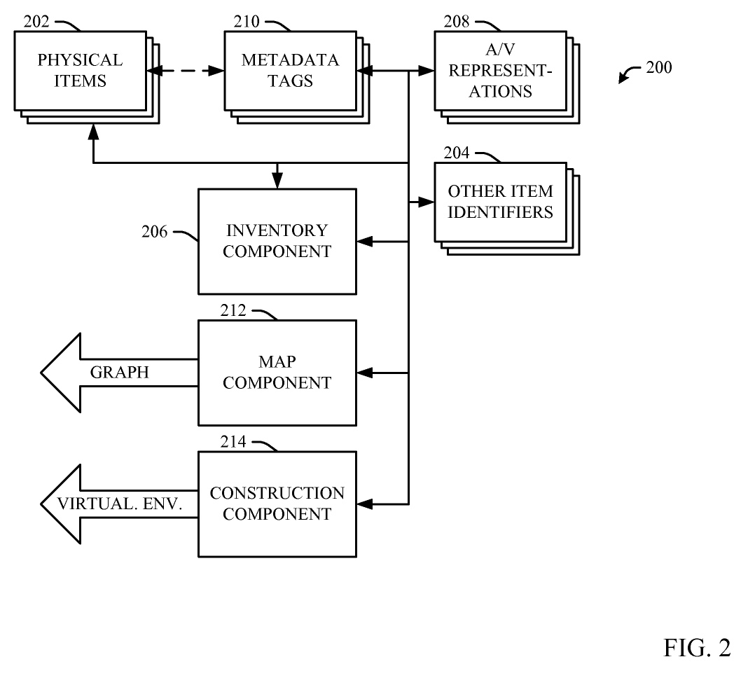

FIG. 2 depicts a representative system 200 for constructing an immersive virtual commerce environment. A seller can allow his inventory to be disclosed through an immersive virtual market—this can include large retailers (e.g., a national department store) as well as smaller retailers (e.g., an individual selling handmade crafts). Information pertaining to physical items 202 can be uploaded to a processing location, such as a central server. In an illustrative instance, the seller can take photographs from different angles of an inventory item with a mobile phone, and use those photographs to facilitate generation of a virtual representation of the inventory or store. Photographs, video, animations, audio or the like can be combined or stitched to generate a rich multi-dimensional representation of products or establishment. In addition to taking the photographs, other item identifiers 204 related to the physical items 202 can be entered by the seller; example identifiers can include a producer of the item, an amount of time spent creating the item, etc.

An audio-visual representation (e.g., ANV representation 208) of the physical item can be created based upon the photographs, entered information, etc. For instance, there can be an evaluation of the photographs taken and a three-dimensional model can be created based upon a result of the evaluation (e.g., with use of a point cloud), an estimation or approximation based upon the photographs, analysis of item data entered by a seller, etc. The inventory component 206 can construct a metadata tag 210 for a physical item 202—the metadata tag 210 can include at least a link to an audio-visual representation of the item precluding a need for literacy in any written language as a prerequisite for online shopping.

A map component 212 can map a relationship graph for the physical items 202. For example, the relationship graph can allow for items that are similar to one another to be grouped together in the graph. Additionally, secondary relationships can also be used that are not immediately disclosed in the graph. For instance, food items that are commonly used together in a recipe can have relationships made by the map component 212; however, unless a user makes a request for items used together, the relationship is not represented in the graph and retained in storage. In an alternative embodiment, non-immediate relationships can be created on an as needed basis. With one aspect, there can be an avatar generated by the map component that emulates physical attributes of a user as well as identify clothing that will fit in a desired manner (e.g., height, weight, color of skin, hair, shoe size, shoe width, . . . ).

Based upon the produced graph, a construction component 214 can generate a virtual environment (e.g., immersive virtual commerce market) that depicts multiple audio-visual representations that are organized in the virtual environment based upon the graph. In one example, an employee of a store can take a video camera and travel through different aisles of the store making a recording on layout, items offered, and the like. The video can be uploaded and the inventory component 206, map component 212, and construction component 214 can function to create an immersive virtual commerce market based upon the video. As subsequent videos are generated, the system 200 can function to update the virtual environment or determine if there should be creation of a new environment. Additionally, modifications can be made such that the virtual environment and physical environment differ. For instance, an inference can be drawn that a specific arrangement of items in the environment is more successful in a virtual space as opposed to a physical space and that arrangement can be used in the virtual environment. A notification can be transferred to the physical store suggesting that the actual store be modified accordingly. It is to be appreciated that the virtual environment can be independent and not represent a particular physical space that actually exists.

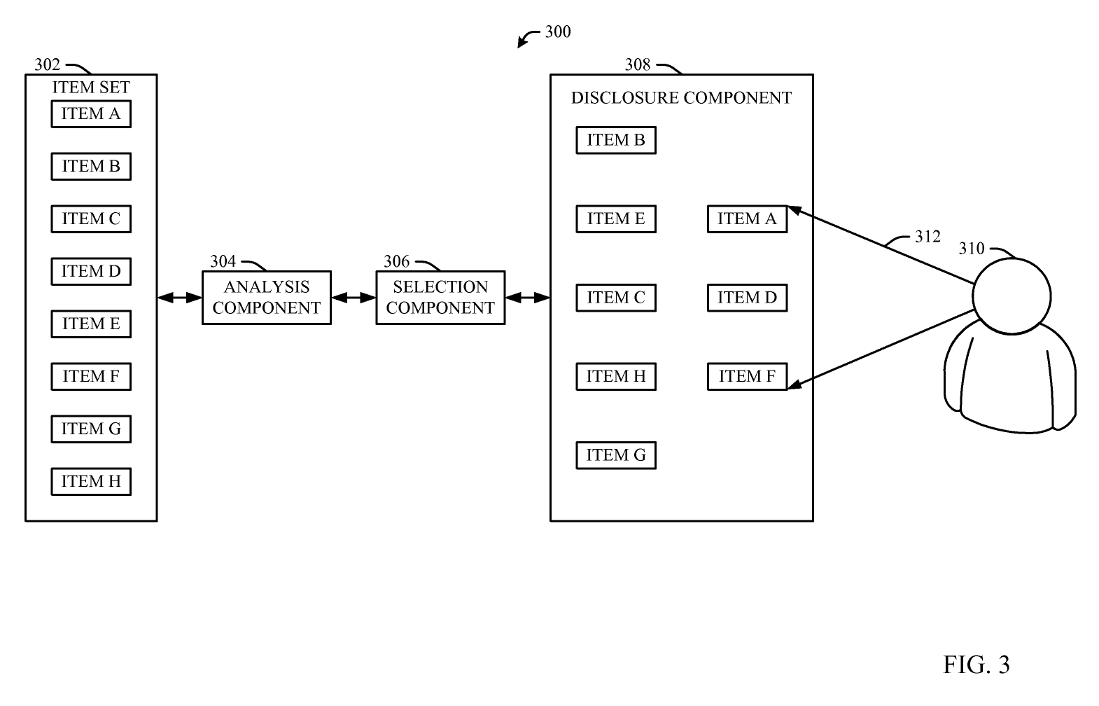

Now referring to FIG. 3, an example system 300 is shown relating to how to arrange a product or a group of products (e.g., items A-H of an item set 302). For example, in selling produce such as apples, it can be desirable to display the most physically attractive apples in a prominent position such as a front of a shelf, a most commonly viewed part of a table, and the like. When the most physically attractive apples are disclosed, a buyer could be under an impression that other apples are of that quality as well have sensory response to the attractive apples that encourages a purchase. In addition, merchandise can be arranged to encourage a shopper to view a greater amount of merchandise or take more time viewing merchandise. For instance, if an antique train dealer is selling trains, old and rare trains could be placed in a prominent position to encourage a potential purchaser to view other merchandise, see what else is being sold, or to take time to view a rare piece.

In one aspect of the disclosed innovation, arrangement of items can be performed proactively, such as through use of artificial intelligence techniques. For example, an analysis component 304 can evaluate potential products of a seller—the evaluation can be performed through visual analysis and/or pattern recognition. Based upon a result of the evaluation, a selection component 306 can choose an arrangement for use in item presentation (e.g., in the environment generated in FIG. 2). In an illustrative instance, the analysis component 304 can evaluate apples of a seller based upon characteristics such as size, color, shape, etc. while the selection component 306 applies weight factors on the different characteristics to determine arrangement. This can be performed through visual analysis of inventory as well as characteristics entered by a user. The user can enter data that a particular antique lamp is highly valuable and that data can be taken into consideration regarding placement. A disclosure component 308 (e.g., liquid crystal display, sound system, etc.) can be used to present the arrangement and a prospective buyer 310 can have a vision range 312 that focuses on items placed in a prominent position.

In addition to arrangement, there can be a determination on axis placement—such as which side of an apple to disclose to a prospective buyer. Moreover, the analysis and selection components 304 and 306 respectively can be used in arrangement of other items related to commerce, such as a layout of a store. For instance, an inference can be made that in a virtual grocery store a cereal aisle should be placed next to a dairy aisle.

The analysis and selection components 304 and 306 respectively can consider specific user characteristics when determining arrangement. Regarding model trains, a first user can prefer trains of a certain era while a second user can have preference towards trains made of a specific material. An arrangement for the first user can highlight trains in the inventory that are of the certain era while an arrangement for the second user can be for those trains of the specific material—thus, arrangements can be constructed to highlight products of a particular interest to a certain user.

When an item is sold or added to inventory, the analysis component 304 or selection component 306 can again perform operation in an attempt to improve arrangement of items. Additionally, if sales are slow, then an inference can be drawn that the arrangement is unsuccessful and the analysis component 304 or selection component 306 can operate again to try to improve the arrangement. Analysis of the unsuccessful arrangement can be performed and the analysis component 304 or selection component 306 can be trained to avoid a similar arrangement in further implementations.

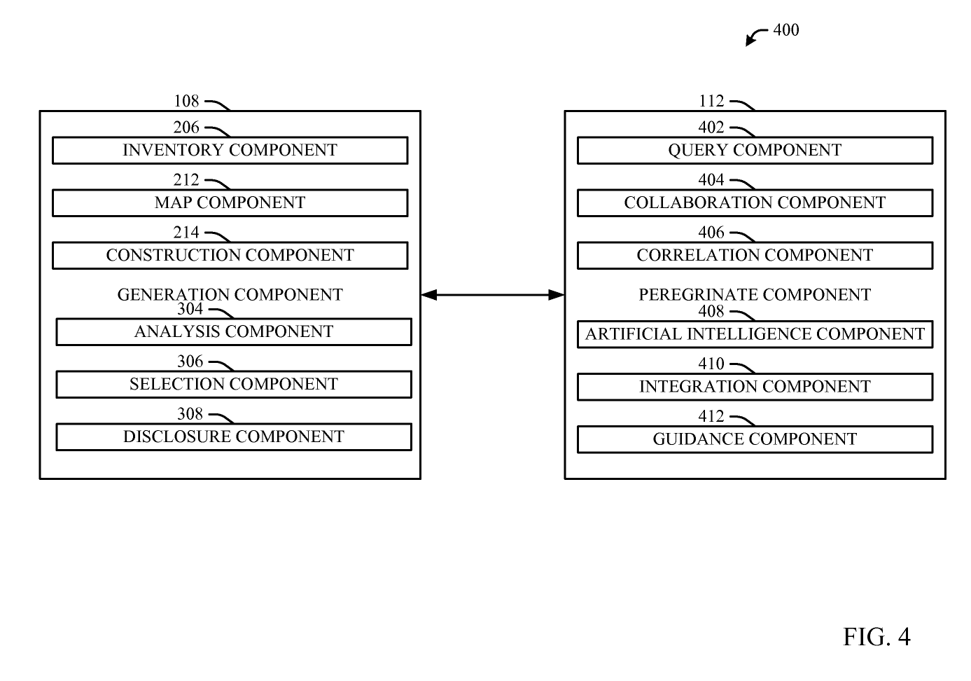

With FIG. 4, an example system 400 is disclosed with a generation component 108 in one configuration and a peregrinate component 112 in one configuration. The generation component 108 can include an inventory component 206 constructs a metadata tag for a physical item (e.g., the tag includes at least a link to an audio-visual representation of the item) as well as a map component 212 that maps a relationship graph for a set of physical items. The map component 212 can map the graph based upon layout of physical items depicted in an image or customized preferences associated with a consumer. A construction component 214 can be employed to generate a virtual environment that depicts multiple audio-visual representations that are organized in the virtual environment based upon the graph. The analysis component 304 and selection component 306 can be used to arrange items in conjunction with operation of the construction component 214. A disclosure component 308 can output the virtual environment.

While using the peregrinate component 112 to navigate through a virtual environment, a customer can perform a search to locate an item in the environment—the search can be performed through use of a query component 402. It is possible that there be multiple customers in one environment at one time and these customers can be aware of one another—a collaboration component 404 can be used to manage engagement between these customers.

A correlation component 406 can associate items of the market with one another through at least one relationship. Multiple relationships can be used for associating different items (e.g., products for sale) with one another. The relationship can include how items can be used together. For instance, different sizes of wood can be grouped together for a person desiring to build a deck. The relationship can also relate to entities that purchase items together within one commerce experience. In this relationship, if a user purchases item A along with item B in one shopping session, a relationship can be formed between item A and item B. More concrete properties of items can also be used in relationships, such as physical proximity of items in the market (e.g., how close items are together), spatial proximity of items in the market (e.g., how items are placed relative to one another), colors of items, texture of items, etc. Combinations of aforementioned relationships as well as other relationships can be practiced in accordance with aspects disclosed herein.

It is to be appreciated that determinations and inferences disclosed herein can be practiced through implementation of artificial intelligence techniques. An artificial intelligence component 408 (e.g., used in practicing the artificial intelligence techniques) can employ one of numerous methodologies for learning from data and then drawing inferences and/or making determinations related to dynamically storing information across multiple storage units (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. In addition, the artificial intelligence component 408 can also include methods for capture of logical relationships such as theorem provers or more heuristic rule-based expert systems. The artificial intelligence component 408 can be represented as an externally pluggable component, in some cases designed by a disparate (third) party.

An integration component 410 can be used that produces a construct that incorporates an item of the market with an item of a user, construct is disclosed through the market. For example, a user can be shopping for a couch—the user can desire to know how a particular couch looks in his living room. A construct can be created that is a virtual representation of the user's living room. Then a visual representation of the couch can be placed in the living room representation so the user can gain perspective on how the particular couch matches with other furniture pieces. Additionally, a user can input his body into a virtual environment to determine how clothing fits; this can include inputting measurements as well as inputting photographs. A guidance component 412 can be used to assist a user in traversing through a virtual environment.

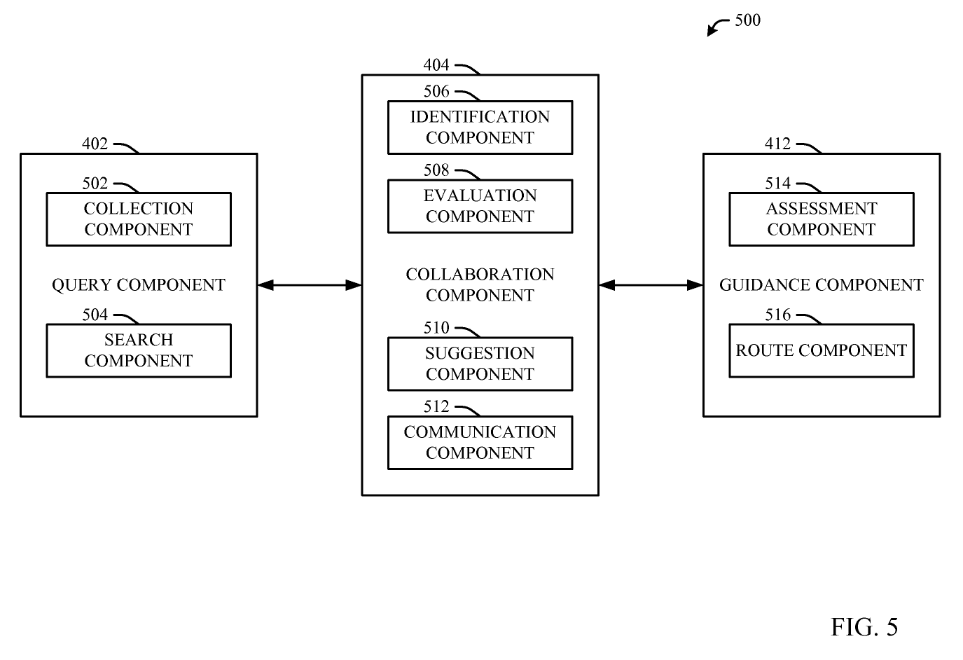

Referring now to FIG. 5, an example system 500 is disclosed for highlighting functionality that can be used in relation to an immersive virtual commerce environment. A query component 402 can be used to perform searches through the environment. A collection component 502 can be used that obtains a query from a user, such as through text entered by a customer in an interface.

A search component 504 can run the query entered by the user as well as appropriate modifications, such as using an artificial intelligence technique to perform a proper search when there is a spelling error. A result of the query can be disclosed to the user through manipulation of an environment. Different manipulations can take place that enable the user to appreciate the results of the query as well as how the results relate to other items.

In one embodiment, the manipulation can be changing visual perspective for the user. With this manipulation, a view can change from a first person view to a third person view, such that items of the result are viewable through the third person view. In another manipulation, an avatar of the user can be moved to a location where search results are shown (e.g., moved into a special area showing search results) or repositioned to face a greater number of results. Additionally, there can be a manipulation of extracting from the market a product that is at least part of the result and presenting a representation of the product to the user. For instance, items can be removed from shelves in a virtual market can placed on a layer that resides on the environment or products that match a search result can surround the user. Combinations of the aforementioned manipulations as well as other manipulations can be practiced.

Collaboration component 404 can be used to facilitate communication between different users in an immersive virtual commerce market. As a user travels though an environment, an identification component 506 can determine at least one entity that at least partially matches to or has a relationship with a user that navigates through the market. An evaluation component 508 can appraise an experience of the at least one entity with the market. The appraisal can include items purchased by the entity, an amount of money spent by the entity, time of the experience, a satisfaction rating of the entity (e.g., with an item, environment, seller, etc.), length of the experience, etc.

A suggestion component 510 can be used that highlights a product within the market based upon a result of the experience appraisal. For example, if a friend of a shopper purchased an item, as an avatar of the user passes by a representation of the item in the market, a notice can be provided to the shopper. There can be interaction between the user and the at least one entity in real time, which can be facilitated by a communication component 512. In one instance, as multiple shoppers are in an environment at one time, each shopper can be represented with an avatar that can be seen by other users. As avatars congregate around a representation of a particular item, an inference can be drawn that the item is of high value and/or desirability. As such, the at least one entity that partially matches to the user is another user that engages with a product of interest to the user. Additionally, targeted advertisements can be used in the environment and these advertisements can be tied to real time interest in a product. With one example, if multiple avatars surround a product and there are three products remaining, a notice can be presented that three of the products remain and that purchase of one or more of the products within a set amount of time results in a discount for that purchase.

In one embodiment, the at least one entity that partially matches to the user is another user with an affirmative relationship with the user. An affirmative relationship is a relationship upon which the user and the entity appreciate as existing. For example, the affirmative relationship can be that the entity is a user that appears on a friends list of the user. However, it is to be appreciated that the affirmative relationship can also be inferred. For example, if a user spends a large amount of time communicating with an entity (e.g., through e-mail, text messaging, etc.), then an inference can be drawn that an affirmative relationship exists—the two users are friends without defining as such through a list.

Guidance component 412 can be used to facilitate a user navigating through the virtual environment. A user can desire to obtain a certain item set, such as a grocery list when shopping for food—the guidance component 412 product a route through the environment for the user to obtain the item set. An assessment component 514 can evaluate an item list of a user and a route component 516 can be used that generates a direction set for the user to follow in order to obtain at least one item of the item list (e.g., the direction set is for navigation through the market).

According to one embodiment, the direction set can be optimized such that the user obtains the items in a least amount of time, travelling a smallest distance, etc. However, the direction set can also be used to take a user past specific items, such as through impulse item locations. Moreover, the guidance component 412 can also provide suggestions to the user based on the item set. For example, if the user requests ‘salsa’ on the item list, the guidance component can suggest a spice level of salsa, brand of salsa, and the like. Based upon an aggregate set of direction sets, the environment can be modified to be more efficient based upon how users commonly travel through the environment.

It is possible for the virtual environment to be generic in nature and monitored by multiple companies. When a user fills a shopping cart and decides to check out, the companies can bid to sell the items (e.g., as a group, individually, as a subset, etc.) for a cheapest amount of money. A user can also decide or have input into which company supplies an item.

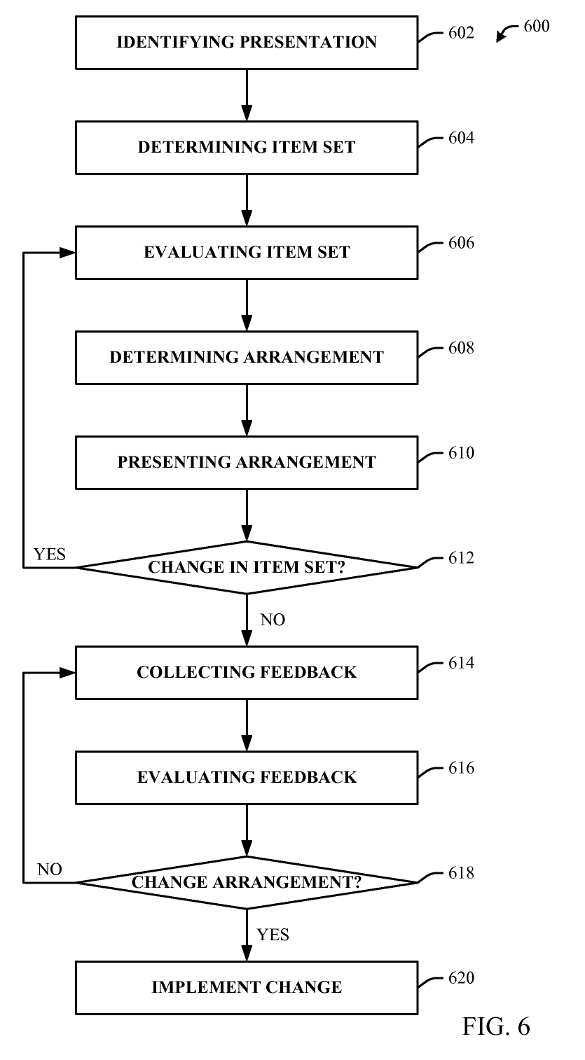

Now referring to FIG. 6, an example methodology 600 is disclosed for determining how to arrange items (e.g., items themselves, representations of items, etc.) for disclosure, such as part of an immersive virtual commerce environment. At action 602, there can be identification that there should be disclosure of items in an arranged manner. This can include when a seller is first offering merchandise, customized for a particular user based upon at least one personal characteristic, performed when there is a change in inventory, etc.

With identification that there should be presentation, a determination can be made at act 604 as to which items should be presented. For instance, there can be limited top shelf space available, so a determination can be made on which items merit placement upon the top shelf. At action 606, there can be evaluating at least a portion of an item set (e.g., performing evaluation in view of how items should be arranged).

There can be proactively determining an arrangement for at least a portion of the item set (e.g., actual items, visual representations of items, etc.) performed at event 608. Different arrangements can be practiced, including physical placement of at least a portion of the item set (e.g., where to place an item independently), spatial placement of at least a portion of the item set (e.g., where to place items relative to one another), an initially presented side of at least a portion of the item set, or a combination thereof, as well as other arrangements. The arrangement can be integrated in a construct (e.g., an immersive virtual environment) and presented at act 610.

A check 612 can be performed that determines if there is a change in the item set and thus represent identifying a change in the item set. A change can take place due to a sale being made, damage to an item, new inventory being collected, etc. If there is a change in the item set, then the methodology 600 can return to action 606. Thus, there can be evaluating at least a portion of the changed item set and proactively determining the arrangement for at least a portion of the changed item set. With one implementation, a determination can be made if the inventory change merits another arrangement being made, such as balancing computer resource consumption against inferred benefit.

With event 614, there can be collecting feedback pertaining to the presented arrangement. The feedback can be active (e.g., a shopper completing a survey on a shopping experience) or passive (e.g., drawing inferences based on shopper behavior and item sales). The feedback can be evaluated at act 616, and at check 618 a determination can be made as to whether the arrangement should be modified based at least in part on the feedback. According to one embodiment, the determination of if the arrangement should be modified is based upon an inference of arrangement success derived from the collected feedback. If there should not be an arrangement change, then the methodology 600 can return to feedback collection; however, if there should be a change then the change can be identified at implemented at act 620.

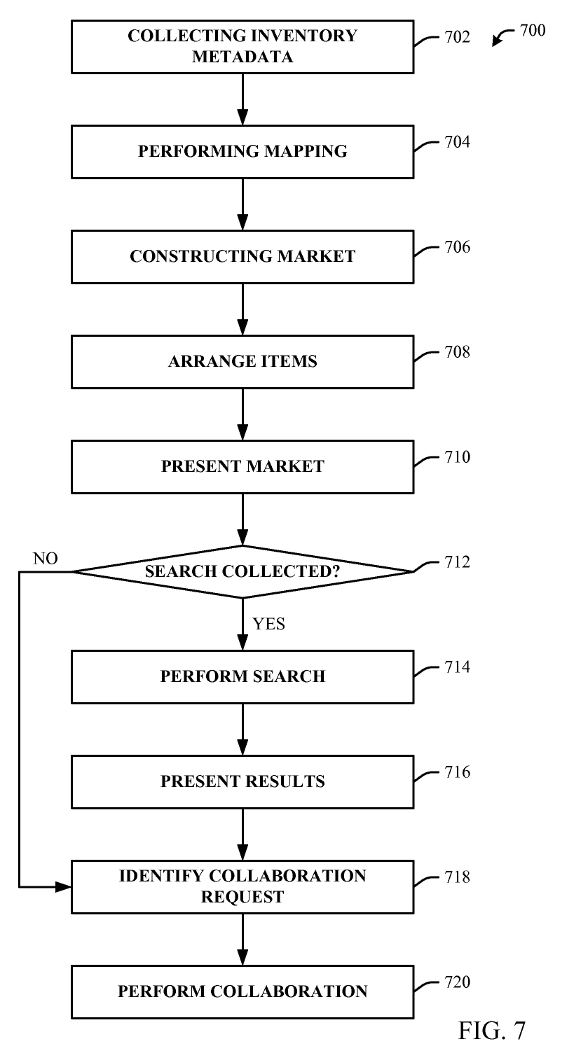

Referring now to FIG. 7, an example methodology 700 is disclosed for presenting an immersive virtual commerce environment and providing search capabilities in relation to the environment. At action 702, there can be collecting inventory metadata, such as items available for sale, physical characteristics of the inventory, and the like. Evaluation of the metadata can occur and at act 704 there can be mapping of the inventory items to audio-visual representations based upon a result of the evaluation.

With the mapping of items to visual representations, a graph can be constructed at action 706 that can be used to present the visual representations. The items can be arranged in the graph at act 708, commonly in such a manner as to make the items more desirable for purchase. The market can be made available to customers through event 710, which can include providing the market to a specific user, providing a general market available to multiple users, presenting an interface for use in navigation of the market, and the like.

A user can navigate through the market as well as perform specific searches to locate particular items. A check 712 can be performed to determine if there is a search request made for an item. If there is a search request made, then the search can be performed at act 714 and results to the search can be presented to the user through event 716.

With search results produced or if there is no search performed, there can also be an identification that collaboration should occur at action 718; however, it is to be appreciated that correlation operation can occur independent of a search being run. With a correlation request, a user can attempt to integrate in a virtual manner an item for sale with another object. For example, when shopping for clothing, matching colors as well as having clothing that is of a certain season can be visually important. A user can input information as to what the item should correlate to; and the correlation can occur at act 720.

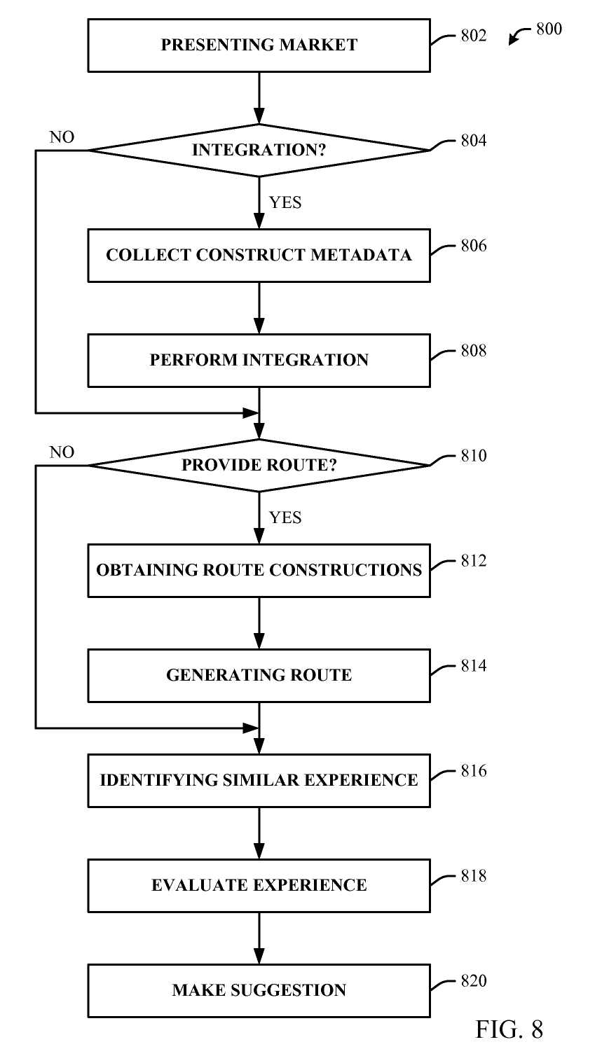

With FIG. 8, an example methodology 800 is shown for providing functionality in relation to an immersive virtual commerce environment. The environment can be presented to a user at event 802 along with an interface that enables to the user to seamlessly traverse through the environment. A check 804 can determine if an item for sale should be placed into a construct, such as a chair being placed in a living room. The living room can be model designed to appeal to shopper in a certain demographic (e.g., a single male living in a condo can have a chair displayed in a loft setting with a married male living in a free-standing home can have the chair displayed in a home den setting) or specific to a shopper.

If it is determined that a construct can be used, metadata pertaining to the item as well as the construct can be collected at action 806. The metadata can be analyzed, a construct can be created, and integration can be performed through event 808. In one implementation, the chair can be available in different varieties such as different colors and patterns. With an example, a determination can be made on which color and/or pattern is most visually appeasing in conjunction with the construct (e.g., visual representation of the room). The determined color and/or pattern can be displayed in the construct—the chair and/or construct can be modified to change color (e.g., “what would this could look like if a wall is painted a different color?” could be answered)

Another check 810 can function (e.g., after integrating, if no integration occurs, etc.) to determine if a route for travel in the environment should be provided to a customer. If there is to be a route provided, then constraints for the route can be collected and analyzed at act 812. For example, if a user would like to browse for a set amount of time, the route can be provided such that items of highest interest to the user are shown in balance against viewing a high number of items. In an alternative embodiment, the environment can be constructed and/or modified based upon the constraints. Based upon a result of the analysis, a route can be generated at event 814 and presented to the user. Experiences by similarly situated users can also be used in determining if a user should make a purchase. Therefore, at event 816 there can be identifying experiences from similar purchasers. These experiences can be evaluated at action 818 and based upon the evaluation a purchase suggestion can be provided at act 820.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

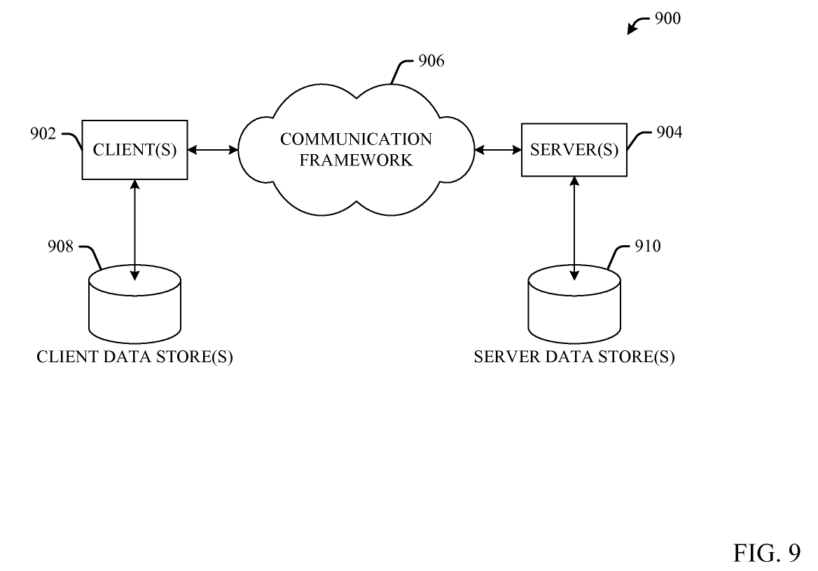

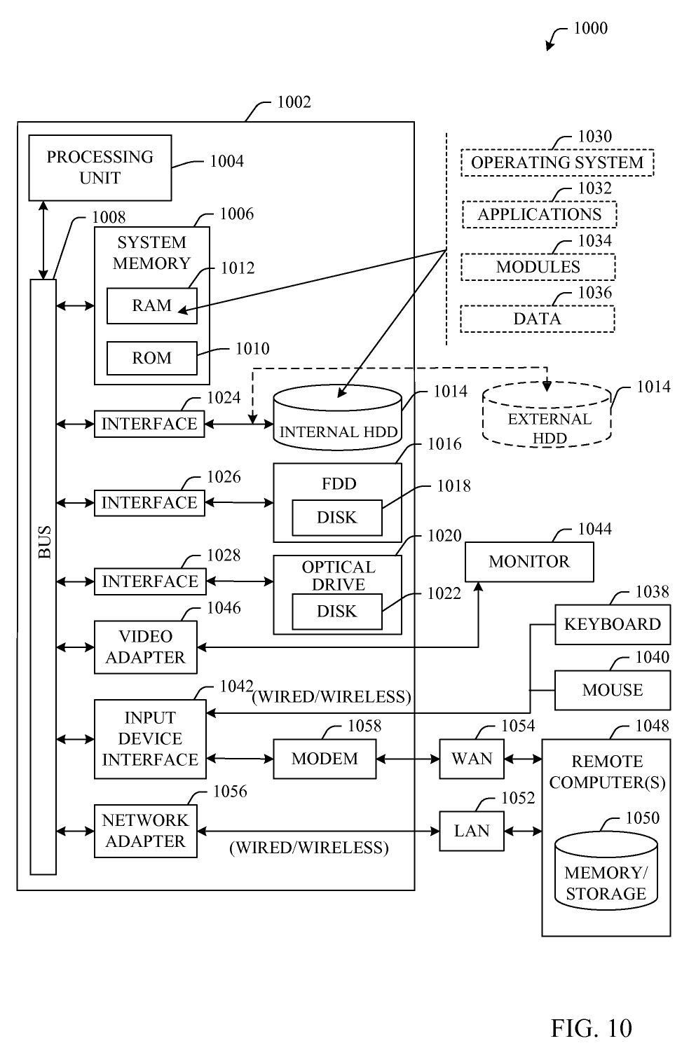

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, biometric input device, image based gesture recognition system, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or can be connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates immersive virtual commerce, comprising:
an inventory component that constructs a metadata tag for a physical item, the tag includes at least a link to an audio-visual representation of the item;
a map component that generates a relationship graph for a set of physical items;
a construction component that produces a virtual environment that depicts multiple audio-visual representations that are organized in the virtual environment based upon the graph; and
a disclosure component that presents the virtual environment.

2. The system of claim 1, the map component generates the graph based upon a layout of physical items depicted in an image.

3. The system of claim 1, the map component generates the graph based upon customized preferences associated with a consumer.

4. A system, comprising:
a generation component that produces a multi-dimensional immersive virtual commerce environment; and
a peregrinate component that facilitates navigation through the immersive virtual commerce environment.

5. The system of claim 4, further comprising:
a collection component that obtains a query from a user; and
a search component that runs the query, a result of the query is disclosed to the user through manipulation of the environment.

6. The system of claim 5, the manipulation includes changing visual perspective for the user, moving an avatar of the user, repositioning the avatar of the user, extracting from the environment a representation of a product that is at least part of the result and presenting the representation of the product to the user, or a combination thereof.

7. The system of claim 4, further comprising:
an identification component that determines at least one entity with a relationship to a user navigating through the environment;
an evaluation component that appraises an experience of the at least one entity with the environment; and
a suggestion component that highlights a product within the environment based upon a result of the experience appraisal.

8. The system of claim 7, the at least one entity that partially matches to the user is another user with an affirmative relationship with the user.

9. The system of claim 7, the at least one entity that partially matches to the user is another user that engages with a product of interest to the user.

10. The system of claim 7, further comprising a communication component that facilitates interaction between the user and the at least one entity in real time.

11. The system of claim 4, further comprising a correlation component that associates items of the environment with one another through at least one relationship.

12. The system of claim 11, the relationship includes how items can be used together, that entities purchase items together within one commerce experience, physical proximity of items in the environment, spatial proximity of items in the environment, color of items, texture of items, or a combination thereof.

13. The system of claim 4, further comprising an integration component that produces a construct that incorporates an item of the environment with an item of a user, the construct is disclosed through the environment.

14. The system of claim 4, further comprising:
an assessment component that evaluates an item list of a user; and
a route component that generates a direction set for the user to follow in order to obtain at least one item of the item list, the direction set is for navigation through the environment.

15. A method operable upon a computer-readable medium, comprising:
evaluating at least a portion of an item set; and
proactively determining an arrangement for at least a portion of the item set, the arrangement is used in presentation of at least a portion of the item set in a multi-dimensional immersive virtual commerce environment.

16. The method of claim 15, the arrangement includes physical placement of at least a portion of the item set, spatial placement of at least a portion of the item set, an initially presented side of at least a portion of the item set, or a combination thereof.

17. The method of claim 15, further comprising:
identifying a change in the item set;
evaluating at least a portion of the changed item set; and
proactively determining the arrangement for at least a portion of the changed item set.

18. The method of claim 15, further comprising:
presenting the arrangement;
collecting feedback pertaining to the presented arrangement; and
determining if the arrangement should be modified based at least in part on the feedback.

19. The method of claim 18, the determination of if the arrangement should be modified is based upon an inference of arrangement success derived from the collected feedback.

20. The method of claim 15, further comprising presenting the arrangement as part of the multi-dimensional immersive virtual commerce environment.
